(19) United States
(12) Patent Application Publication
(10) Pub. No.: US 2010/0304769 A1
(43) Pub. Date: Dec. 2, 2010

(54) POWER CONTROL IN A WIRELESS COMMUNICATION SYSTEM

(75) Inventors: Simon Fellows, Wiltshire (GB); Simon Huckett, Bristol (GB); Godfrey Da Costa, Clifton Bristol (GB)

Correspondence Address: HITT GAINES P.C., P.O. BOX 832570, RICHARDSON, TX, 75083, US

(73) Assignee: ICERA INC., Wilmington, DE (US)

(21) Appl. No.: 12/808,175

(22) PCT Filed: Nov. 12, 2008
(86) PCT No.: PCT/EP2008/065420

§ 371 Date: Aug. 17, 2010

(30) Foreign Application Priority Data
Dec. 13, 2007 (GB) 0724337.1

(51) Int. Cl. H04B 7/00

(52) U.S. Cl. 455/507

(57) ABSTRACT

An inter-radio-access-technology device comprising: an interface for communicating over a wireless cellular network, and a processor arranged to execute code for performing operations handling communications via the interface according to a plurality of different radio access technologies. The processor is operable to execute code using any selected one of a plurality of different instruction sets, each set being configured for performing operations according to a respective one of the radio access technologies. The device is operable to dynamically switch between the radio access technologies, by selecting corresponding code for execution by the processor and selecting the corresponding instruction set for use in execution of the selected code.

### CROSS-REFERENCE TO RELATED APPLICATION

This application is the National Stage of, and therefore claims the benefit of, International Application No. PCT/EP2008/065420 filed on Nov. 12, 2008, entitled “RADIO ACCESS TECHNOLOGY,” which was published in English under International Publication Number WO 2009/0074420 on Jun. 18, 2009, and has a priority date of Dec. 13, 2007, based on the application GB 0724337.1. Both of the above applications are commonly assigned with this National Stage application and are incorporated herein by reference in their entirety.

### TECHNICAL FIELD

The present invention relates to instructions sets for performing operations handling communications over a wireless cellular network.

### BACKGROUND

In the field of wireless cellular communications, there has been increasing interest in recent years in the idea of moving more of the signal processing operations and other related operations of the transceiver into software. A transceiver with a tendency towards software implementation is sometimes referred to as a software modem, or “soft modem”. The principle behind software modem is to perform a significant portion of the operations required for the wireless communications in a generic, programmable, reconfigurable processor, rather than in dedicated hardware.

An advantage of a soft modem type system is that it can be programmed and potentially reprogrammed to handle different radio access technologies (RATS). Conventionally, different radio access technologies would require different dedicated hardware to be included on a phone or other wireless terminal, and a “multimode” terminal adapted to handle multiple radio access technologies would have to include different sets of dedicated hardware. This problem is solved by software modem techniques, in which the differences in communicating according to different radio access technologies can be handled in software. For example, the processor could be programmed to handle both 2G and 3G cellular standards, including for example perhaps one or more of the GSM, UMTS, EDGE, High Speed Downlink Packet Access (HSDPA), and High Speed Uplink Packet Access (HSUPA), and 3GPP Long Term Evolution (LTE) standards.

However, the capacity of conventional processors to handle multiple radio access technologies is limited, particularly in lower-cost processors as typically used in handheld consumer devices such as mobile phones. It would be desirable to find a way of improving the ability of a processor to handle multiple radio access technologies.

### SUMMARY

According to one aspect of the present invention, there is provided an inter-radio-access-technology device comprising: an interface for communicating over a wireless cellular network; a first storage means storing code for performing operations handling communications via the interface according to a plurality of different radio access technologies; a second storage means storing definitions of plurality of different instruction sets, each set being configured for performing operations according to a respective one of the radio access technologies; a processor arranged to execute the code, the processor being operable to execute code using any selected one of the instruction sets by reference to the second storage means; and selection means operable to dynamically switch between the radio access technologies, by selecting corresponding code for execution by the processor and selecting the corresponding instruction set for use in execution of the selected code.

Thus the present invention advantageously provides a mechanism for dynamically switching processor instruction sets, to allow different instructions when performing inter-RAT operations.

According to another aspect of the present invention, there is provided method of dynamically switching between radio access technologies in a processor, the method comprising: selecting a first instruction set corresponding to the first radio access technology; executing code on a processor using the first instruction set, to perform operations handling communications over a wireless cellular network according to the first radio access technology; switching to a second radio access technology; selecting a second instruction set corresponding to the second radio access technology; and executing code on the processor using the second instruction set, to perform operations handling communications over a wireless cellular network according to the second radio access technology.

According to another aspect of the present invention, there is provided a computer program product for dynamically switching between radio access technologies, the program comprising code which when executed by a processor performs the steps of: selecting a first instruction set corresponding to the first radio access technology; executing code using the first instruction set, to perform operations handling communications over a wireless cellular network according to the first radio access technology; switching to a second radio access technology; selecting a second instruction set corresponding to the second radio access technology; and executing code using the second instruction set, to perform operations handling communications over a wireless cellular network according to the second radio access technology.

According to another aspect of the present invention, there is provided an inter-radio-access-technology device comprising: an interface for communicating over a wireless cellular network; and a processor arranged to execute code for performing operations handling communications via the interface according to a plurality of different radio access technologies, the processor being operable to execute code using any selected one of a plurality of different instruction sets, each set being configured for performing operations according to a respective one of the radio access technologies; wherein the device is operable to dynamically switch between the radio access technologies, by selecting corresponding code for execution by the processor and selecting the corresponding instruction set for use in execution of the selected code.

### BRIEF DESCRIPTION OF THE DRAWINGS

For a better understanding of the present invention and to show it may be carried into effect, reference will now be made by way of example to the accompanying drawings.

FIG. 1 is a schematic block diagram of a communication device;

FIG. 2 is a schematic block diagram of an execution unit;

FIG. 3 is a schematic block diagram of an execution unit with variable instruction sets; and

FIG. 4 is a schematic block diagram of an alternative arrangement of instruction sets.

### DETAILED DESCRIPTION

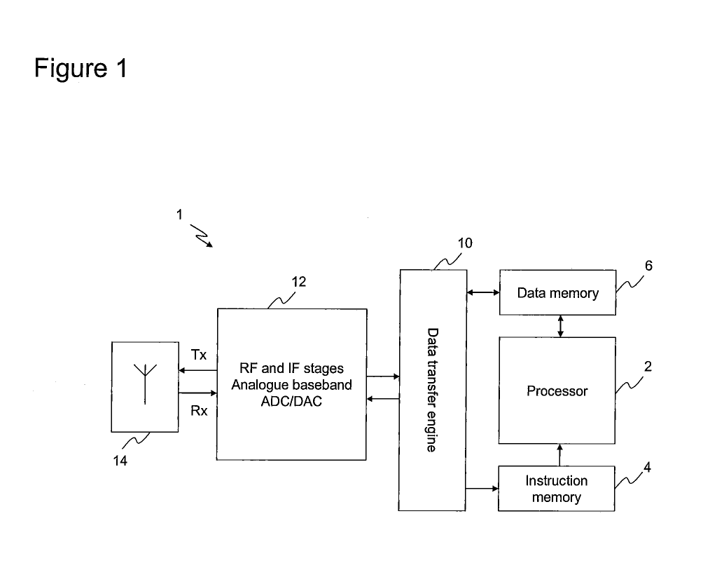

Those skilled in the art to which this application relates will appreciate that other and further additions, deletions, substitutions and modifications may be made to the described embodiments. FIG. 1 is a schematic block diagram of a device 1 for transmitting and receiving signals in a wireless communication system. Such a device can be realized in a number of different ways, but in the example of FIG. 1 a transceiver in the form of an analog interface 12 comprising radio frequency (RF) and intermediate frequency (IF) stages is arranged to receive and transmit wireless signals (Rx and Tx) via one or more antennas 14. The analog interface 12 includes components for processing the received analog radio signals Rx and providing digital signal samples r(k). This can be achieved in different ways which are known in the art.

The analog interface 12 is arranged to supply the samples r(k) to a data transfer engine 10, which is arranged to communicate with a processor 2, an instruction memory 4, and a data memory 6. The processor 2 is responsible for processing the samples r(k). The processor can execute a number of different operations which are held in the instruction memory 4 in the form of code sequences.

The device 1 may be referred to as a software modem, or soft modem. The software modem can be a soft baseband modem. That is, on the receive side, all the radio functionality from receiving RF signals from the antenna up to and including mixing down to baseband is implemented in dedicated hardware. Similarly, on the transmit side, all the functionality from mixing up from baseband to outputting RF signals to the antenna is implemented in dedicated hardware. However, all operations in the baseband domain are implemented in software stored on the memory 4 and executed by the processor 2. While this is one implementation, solutions where the RF/IF stage is not implemented by dedicated hardware are also envisaged.

In one embodiment, the dedicated hardware in the receive part of the RF/IF stages in the analog interface 12 may comprise a low noise amplifier (LNA), mixers for downconversion of the received RF signals to IF and for downconversion from IF to baseband, RF and IF filter stages, and an analog to digital conversion (ADC) stage. An ADC is provided on each of in-phase and quadrature baseband branches for each of a plurality of receive diversity branches. The dedicated hardware in the transmit part of the RF/IF stages in interface 12 may comprise a digital to analog conversion (DAC stage, mixers for upconversion of the baseband signals to IF and for upconversion from IF to RF, RF and IF filter stages, and a power amplifier (PA). Details of the required hardware for performing such basic radio functions will be known to a person skilled in the art. Some, all, or none of the components of the analog interface 12 may be implemented in the same chip or housing as the processor 2.

The software may then perform a plurality of different operations such as:
Modulation and demodulation,
Interleaving and deinterleaving,
Rate matching and dematching,
Modulation and demodulation,
Channel estimation,
Equalization,
Rake processing,
Bit log-likelihood ratio (LLR) calculation,
Transmit diversity processing—Receive diversity processing,
Multiple transmit and receive antenna (MIMO) processing,
Voice codecs,
Link adaptation through power control or adaptive modulation and coding, and
Cell measurements.

The details of some or all of such operations will differ depending on which radio access technology (RAT) is being used.

In one embodiment, the chip used to implement the device is manufactured by Icera and sold under the trade name Livanto®. Such a chip has a specialized processor platform described for example in WO2006/117562.

The device is configured as an inter-radio-access-technology (inter-RAT) device. That is, firstly, the program memory 4 contains different portions of code for performing signal processing operations and other related operations according to a plurality of different radio access technologies, i.e., different communication standards. And secondly, the device is configured to switch dynamically between the different RATs during operation depending one or more of certain factors, examples of which are discussed below. The radio access technologies supported could for example include one or more of: GSM, UMTS, EDGE, High Speed Downlink Packet Access (HSDPA), and High Speed Uplink Packet Access (HSUPA), and 3GPP Long Term Evolution (LTE) standards.

The processor can execute scheduling software from the instruction memory 4 for scheduling which RAT to select at any given time. The selection is dynamic in that different RATs can be selected “on the fly” or “ad-hoc” at different times during the ongoing operation of the device.

In one embodiment, the scheduling software may select the RAT based on a priority system whereby different priority levels are allocated to different message queues in which are queued different requests for operations to be performed by the processor. For example, these different priority queues may be a “background” queue, a “multi-frame” queue, a “frame” queue, and a “slot” queue. These priority based message queues are used to enable multiple requests for scheduling operations. The slot queue is the highest priority (operations performed every slot), followed by the “frame” queue (operations performed every frame), then followed by “multi-frame” (operations performed less than once per frame), with “background” being the lowest priority (operations performed in the background). Higher priority operations will always pre-empt lower priority operations, even if they are already running. When scheduling requests are made via the queues, the requesting functions specify the RAT that is required or that no specific RAT is required. When an operation is scheduled to run, the scheduler (if required) switches in the required RAT. When the operation has completed, a base RAT may be restored if different from the current RAT. Thus the selection of the RAT can be performed on a per-operation basis.

For example, operations in the “slot” priority category may include the gathering of data samples, operations in the “frame” priority category may include the processing of samples, operations in the “multi-frame” category may include reporting processing results, and operations in the “background” category may include ciphering.

Alternatively or additionally, the scheduling software may select the RAT based on channel conditions. For example, a certain RAT may be selected in low signal-to-noise ratio (SNR) and/or signal-to-interference ratio (SIR) conditions, and/or a certain RAT may be selected in certain multi-path conditions, etc.

Further, the scheduling software may select the RAT based on one or more certain performance requirement, such as a quality target whereby a certain upper limit to the bit-error rate must not be exceeded, with different RATs delivering different performance under different channel conditions.

Further, the scheduling software may select the RAT based on the availability of processing resources. Different RATs will incur different processing costs in different channel conditions, and so for example the cost of each RAT under current conditions may need to be taken into consideration and/or the cost of each RAT may need to be balanced against the processing resources consumed by other concurrent tasks performed by the processor.

Further, the scheduling software may select the RAT based on availability of cells. For example, if no 3G cells are available, then the software may have to select a 2G RAT. This availability could also take into account a cell measurement from nearby cells, e.g., such that if the signal strength from 3G cells is too low then 2G cells would have to be selected.

Further, a user of a mobile terminal (e.g., mobile phone) in which the devices is embodied could also make a selection as to RAT, either to indicate a preference or to force a certain RAT.

By way of example, the following is described in relation to an inter-RAT device for switching between the 2G standard GSM and the 3G standard UMTS, but it will be understood that the principle of the invention can apply to any different RATs.

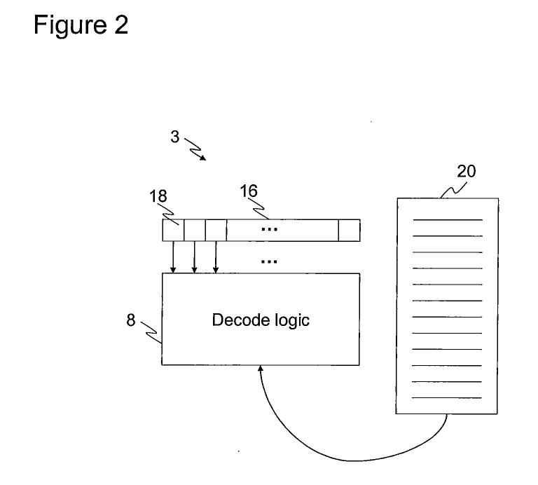

As shown schematically in FIG. 2, the processor 2 comprises an execution unit 3 having an instruction buffer 16 and decode logic 8. The instruction buffer 16 comprises a plurality of bits 18 (e.g., sixteen bits), of which those holding the instruction's op-code are connected to the decode logic 20. Further, the decode logic 8 may be arranged to have access to a table 20 of instruction definitions, which may for example be stored in a memory such as data memory 6, instruction memory 4, or in registers on the processor 2 (not shown).

In operation, the processor fetches an instruction word from the instruction memory 4 into the instruction buffer 16 of the execution unit 3. The decode logic 8 reads each bit of the op-code in the instruction buffer 16, and refers to the configuration table 20 to determine how to execute the instruction. That is, the configuration table 20 maps instruction values (op-codes) appearing in the instruction buffer onto actions to be carried by the execution unit 3. Thus the table enables the use of “configurable instructions”, whereby a manufacturer can define a set of instructions as appropriate to the application for which the processor is intended. The instruction set may be totally configurable so that all instructions are configured with a configuration table. Nonetheless, the possibility of some basic instructions being hard-coded in addition to the configurable instructions is not excluded.

For the purpose of inter-RAT processing, it is desirable to configure different instructions for performing operations specific to each particular RAT supported, e.g., certain instructions specific to GSM operations and other instructions specific to UMTS operations.

However, the number of entries in the configuration table is limited. This can be problematic for inter-RAT processing because there may be insufficient configurable instructions available to handle all of the desired RATs (or at least to handle them as efficiently as required). For example, there may be insufficient configurable instructions to handle both base-RAT such as GSM and an additional inter-RAT such as UMTS.

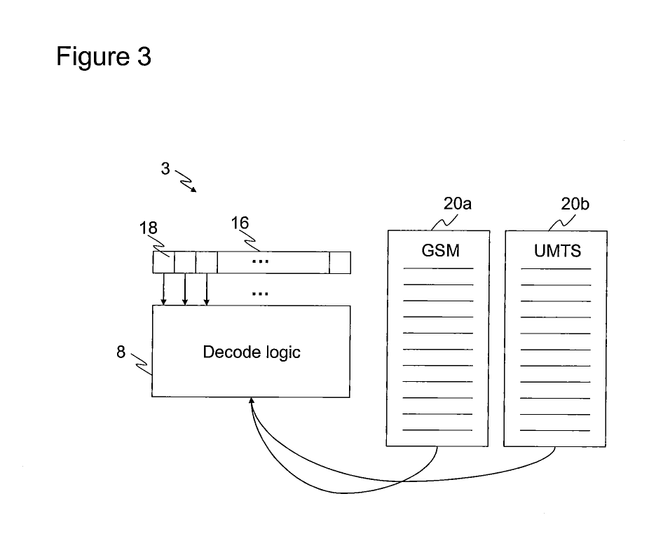

An embodiment of the present invention which overcomes this problem is now described in relation to FIG. 3. Here, the decode logic 8 has access to two separate configuration tables 20a and 20b, each comprising a respective set of instruction definitions specifically tailored to a particular corresponding RAT, in this example GSM and UMTS respectively. Again, the tables could be stored in a memory such as data memory 6, instruction memory 4 or in registers on the processor 2 (not shown).

In operation, when the scheduling software running selects a particular RAT, it causes the decode logic 8 to execute code from the instruction memory 4 in a manner as defined in either the first table or the second table 20a or 20b, depending on which RAT is selected by the scheduling software. This could be achieved for example by arranging the decode logic to read the table from a predetermined memory location and then configuring the scheduling software to load the different tables into that memory location as required. Or it could be achieved by providing special switching logic in the decode unit, which could for example switch between tables in dependence on a certain value written to a register by the scheduling software, or which could alternatively be controlled by a new dedicated instruction which acts directly on the decode logic 8.

As mentioned, the selection of RAT can be on a per-operation basis. So with the multiple instruction set tables 20a and 20b, the device is configured to switch in the corresponding instruction set 20a or 20b depending on the particular operation being performed at the time. But on whatever basis the scheduling software selects the RAT, the device is configured to automatically switch to the appropriate table “ad hoc”.

Note, although only two tables 20a and 20b are shown here to define two respective RAT instruction sets, it will be appreciated that any number of tables could potentially be provided to handle any number of RATS.

Without the additional configurable processor instructions, the inter-RAT measurements would have to be executed using sub-optimal code that does not fully exploit the power of the processor 2. Additionally, all the inter-RAT code would have to be duplicated for all supported RATs to perform the same measurement functions as the optimized base-RAT code that can use the configurable instruction set.

However, with the additional configurable instruction table or tables, the following advantages may be achieved.
It allows any number N of radio access technologies to be supported, each of which can use a dedicated instruction set. This avoids the need to either use sub-optimal code or to create an N×M configuration table where M is the size of the existing table.
It allows for any number of operation specific configuration tables to be loaded, regardless of the actual RAT used. That is, an operation might have to be performed that is not a 3GPP measurement but, for example, a JPEG compression algorithm, MPEG2 decode, etc.
It allows configuration tables to be switched in and out dynamically on an operation-by-operation basis, even taking into account scheduling priority of those operations.

The switching between instruction sets is dynamic in that different instruction sets can be selected at different times during the ongoing functioning of the processor 2. If a single table or perhaps an FPGA (field programmable gate array) was used to define instructions, then the instruction set could of course be reconfigured to accommodate different RATs, but this would involve shutting down the device and reprogramming it, which could not be achieved “on the fly”. Whereas in the present case, the device can automatically switch between instruction sets as appropriate to the RAT selected for use at any given time, without the need for any such shutting down or reprogramming, and potentially without the need for the user to have any awareness of what is going on.

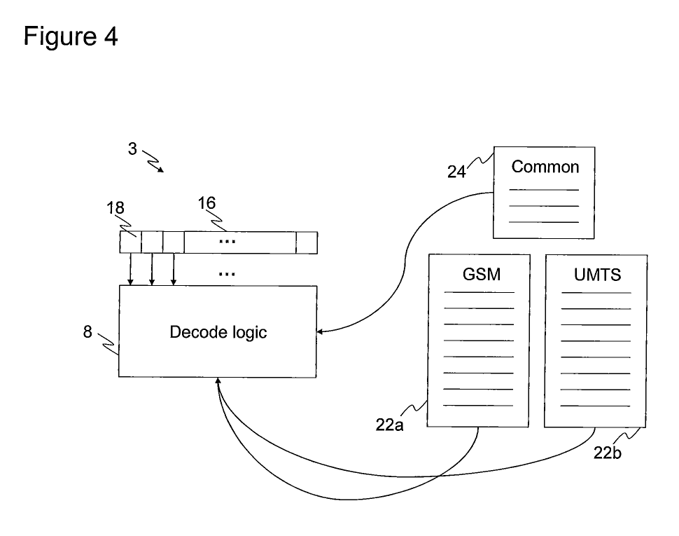

One embodiment of the invention is now described in relation to FIG. 4. In the above example described in relation to FIG. 3, each configuration table may in fact need to comprise both RAT-specific instruction definitions and definitions of instructions which are common to both RATs. So in the example of FIG. 3, these common instruction definitions are therefore duplicated on both tables, which is an inefficient use of resources.

Therefore in the embodiment of FIG. 4, the two tables 20a and 20b are replaced with two smaller RAT-specific configuration tables 22a and 22b (e.g., for GSM and UMTS respectively) and one common RAT configuration table 24. Like the RAT specific tables, the common table 24 can also be a configurable set of instruction definitions stored in memory.

The decode logic 8 is then arranged such that it always executes the common instructions using the common definitions, but that it switches between the RAT specific tables 22a and 22b in the manner described above when different RATs are selected by the scheduling software.

The above embodiments have been described by way of example only, and other variations or application of the present invention may be apparent to a person skilled in the art given the disclosures herein. For example, it will be appreciated that any number of different instruction sets could be supported to handle any number of different radio access technologies. Further, although the above has been described in relation to configurable instruction tables, the different instruction sets could be implemented by different portions of hardware decode logic. The scope of the invention is not limited by the above description, but only by the following claims.

1.-24. (canceled)

25. An inter-radio-access-technology device comprising:
an interface for communicating over a wireless cellular network;
first storage means storing code for performing operations handling communications via said interface according to a plurality of different radio access technologies;
second storage means storing definitions of plurality of different instruction sets, each set being configured for performing operations according to a respective one of the radio access technologies;
a processor arranged to execute said code, the processor being operable to execute code using any selected one of said instruction sets by reference to said second storage means; and
selection means operable to dynamically switch between said radio access technologies, by selecting corresponding code for execution by the processor and selecting the corresponding instruction set for use in execution of the selected code.

26. The device according to claim 25, wherein the selection means comprises scheduling code which when executed the processor controls the dynamic selection of the radio access technology.

27. The device according to claim 26, wherein the scheduling code is configured to select the radio access technology in dependence on the operation being performed.

28. The device according to claim 27, wherein the processor is arranged to generate a plurality of requests for scheduling of said operations, each request having an associated priority level and requested radio access technology, and the scheduling code is configured to select the radio access technology in dependence on said priority levels requested radio access technologies.

29. The device according to claim 25, wherein the selection means is arranged to select the radio access technology in dependence on one or more characteristics of an external environment in which the device operates.

30. The device according to claim 29, wherein said one ore more characteristics comprise at least an availability of cells supporting said radio access technologies.

31. The device according to claim 29, wherein said one or more characteristics comprise at least an estimate of a channel condition of a wireless channel over which said data is communicated.

32. The device according to claim 25, wherein the selection means is arranged to select the radio access technology in dependence on one or more performance requirements.

33. The device according to claim 25, wherein the selection means is arranged to selected the radio access technology in dependence on the available processing resources of said processor.

34. The device according to claim 25, wherein the selection means is arranged to select the required radio access technology in dependence on a selection by a user of the device.

35. The device according to claim 25, wherein the processor is further configured to execute code using a common instruction set common to said plurality of radio access technologies.

36. A method of dynamically switching between radio access technologies in a processor, the method comprising:
selecting a first instruction set corresponding to the first radio access technology;
executing code on a processor using said first instruction set, to perform operations handling communications over a wireless cellular network according to the first radio access technology;
switching to a second radio access technology;
selecting a second instruction set corresponding to the second radio access technology; and
executing code on said processor using said second instruction set, to perform operations handling communications over a wireless cellular network according to the second radio access technology.

37. The method according to claim 36, wherein the dynamic selection of the radio access technology is controlled by scheduling code executed on the processor.

38. The method according to claim 37, comprising using the scheduling code to select the radio access technology in dependence on the operation being performed.

39. The method according to claim 38, comprising generating a plurality of requests for scheduling of said operations, each request having an associated priority level and requested radio access technology, and using the scheduling code to select the radio access technology in dependence on said priority levels requested radio access technologies.

40. The method according to claim 36, comprising selecting the radio access technology in dependence on one or more characteristics of an external environment in which the device operates.

41. The method according to claim 40, wherein said one ore more characteristics comprise at least an availability of cells supporting said radio access technologies.

42. The method according to claim 40, wherein said one or more characteristics comprise at least an estimate of a channel condition of a wireless channel over which said data is communicated.

43. The method according to claim 36, comprising selecting the radio access technology in dependence on one or more performance requirements.

44. The method according to claim 36, comprising selecting the radio access technology in dependence on the available processing resources of said processor.

45. The method according to claim 36, comprising selecting the radio access technology in dependence on a selection by a user of the device.

46. The method according to claim 36, comprising executing code on said processor using a common instruction set common to said plurality of radio access technologies.

47. A computer program product for dynamically switching between radio access technologies, the program comprising code which when executed by a processor performs the steps of:
selecting a first instruction set corresponding to the first radio access technology;
executing code using said first instruction set, to perform operations handling communications over a wireless cellular network according to the first radio access technology;
switching to a second radio access technology;
selecting a second instruction set corresponding to the second radio access technology; and
executing code using said second instruction set, to perform operations handling communications over a wireless cellular network according to the second radio access technology.

48. An inter-radio-access-technology device comprising:
an interface for communicating over a wireless cellular network; and
a processor arranged to execute code for performing operations handling communications via said interface according to a plurality of different radio access technologies, the processor being operable to execute code using any selected one of a plurality of different instruction sets, each set being configured for performing operations according to a respective one of the radio access technologies;
wherein the device is operable to dynamically switch between said radio access technologies, by selecting corresponding code for execution by the processor and selecting the corresponding instruction set for use in execution of the selected code.
